(19) United States
(12) Patent Application Publication
(10) Pub. No.: US 2024/0243437 A1
(43) Pub. Date: Jul. 18, 2024

(54) Solid-State Traction Battery Having Battery Cells with Electrical Insulator Coated Electrode Edge

(71) Applicant: Ford Global Technologies, LLC, Dearborn, MI (US)

(72) Inventors: Hyukkeun Oh, Ann Arbor, MI (US); Xin Liu, Novi, MI (US); Andrew Robert Drews, Ann Arbor, MI (US)

(73) Assignee: Ford Global Technologies, LLC, Dearborn, MI (US)

(21) Appl. No.: 18/097,602

(22) Filed: Jan. 17, 2023

(51) Int. Cl. H01M 50/474; H01M 10/0525; H01M 50/54

(52) U.S. Cl. CPC H01M 50/474; H01M 10/0525; H01M 50/54; H01M 2220/20

(57) ABSTRACT

A battery cell of a solid-state battery, such as a solid-state traction battery of an electrified vehicle, includes first and second electrodes and a solid electrolyte. The solid electrolyte is assembled (e.g., laminated) to the first electrode and is sandwiched between the first electrode and the second electrode in a stack. The first and second electrodes have a same size surface, and the solid electrolyte has a surface no larger than the surface of the first electrode. An edge of the first electrode is coated with electrical insulating material. An edge of the second electrode and/or an edge of the solid electrolyte may also be coated with electrical insulating material. The first electrode may be an anode and the second electrode may be a cathode. Alternatively, the first electrode may be a cathode and the second electrode may be an anode.

### TECHNICAL FIELD

The present disclosure relates to a solid-state traction battery for an electrified vehicle.

### BACKGROUND

An electrified vehicle includes a traction battery for providing power to a motor of the vehicle to propel the vehicle. The traction battery is comprised of battery cells.

### SUMMARY

A solid-state battery cell (SSB cell) having a first electrode, a second electrode, and a solid electrolyte is provided. The solid electrolyte is assembled to the first electrode and sandwiched between the first electrode and the second electrode in a stack. The first electrode and the second electrode have a same size surface and the solid electrolyte has a surface no larger than the surface of the first electrode. An edge of the first electrode is coated with electrical insulating material.

An edge of the second electrode may be coated with electrical insulating material.

The surface of the solid electrolyte may be as large as the surface of the first electrode and an edge of the solid electrolyte may be coated with electrical insulating material.

The SSB cell may further include a current collector having a main portion and a current collector tab extending therefrom. The second electrode is sandwiched between the main portion of the current collector and the solid electrolyte in the stack. The second electrode may further have a second electrode tab extending along a portion of the current collector tab of the current collector. The edge of the first electrode that is coated with electrical insulating material may be adjacent to the second electrode tab.

The electrical insulating material coated on the edge of the first electrode may be screen, ink jet, or roller printed on the edge of the first electrode.

The first electrode may be an anode, and the second electrode may be a cathode. Alternatively, the first electrode may be a cathode, and the second electrode may be an anode.

The solid electrolyte may be assembled to the first electrode by being laminated to the first electrode.

Another SSB cell is also provided. The SSB cell includes a first electrode, a second electrode, and a solid electrolyte. The first electrode, the second electrode, and the solid electrolyte each having a surface and side edges. The surfaces of the first electrode, the second electrode, and the solid electrolyte extend in a x-y plane. The side edges of the first electrode, the second electrode, and the solid electrolyte are arranged around a periphery of the respective surfaces and extend in a z-direction. The surface of the first electrode and the surface of the second electrode are of a same size. The solid electrolyte is laminated to the first electrode such that the surface of the solid electrolyte is no larger than the surface of the first electrode. The first electrode, the second electrode, and the solid electrolyte are arranged along the z-direction in a stack with the solid electrolyte sandwiched between the first electrode and the second electrode. At least one of the side edges of the first electrode is coated with electrical insulating material.

An electrified vehicle is also provided. The electrified vehicle includes a traction battery having a first battery cell and a second battery cell. The first battery cell and the second battery cell are arranged in a group stack. Each battery cell includes a first electrode, a second electrode, and a solid electrolyte. In each battery cell, the solid electrolyte is assembled to the first electrode and sandwiched between the first electrode and the second electrode in a cell stack, the first electrode and the second electrode have a same size surface and the solid electrolyte has a surface no larger than the surface of the first electrode, and an edge of the first electrode is coated with electrical insulating material.

### BRIEF DESCRIPTION OF THE DRAWINGS

FIG. 1 illustrates a block diagram of a battery electric vehicle (BEV) having a solid-state traction battery (SSB);

FIG. 2 illustrates a legend for battery cell components shown in the sketches of the drawings;

FIG. 3A illustrates a cross-sectional sketch of a group stack of SSB cells, each SSB cell including a negative current collector (i.e., an anode current collector), a negative electrode (i.e., an anode), a solid electrolyte, a positive electrode (i.e., a cathode), and a positive current collector (i.e., a cathode current collector) stacked in that order on one another in a SSB cell stack, wherein in these SSB cells the solid electrolyte is assembled (e.g., laminated) to the anode;

FIG. 3B illustrates a plan sketch of the stack of SSB cells shown in FIG. 3A;

FIG. 3C illustrates a perspective sketch of the stack of SSB cells shown in FIG. 3A, this perspective sketch further illustrating that the stack of SSB cells shown in FIG. 3A does not have an overhang design as neither the anode nor the cathode overhang one another;

FIG. 3D illustrates a perspective sketch of a stack of SSB cells shown in FIG. 3A in which this stack of SSB cells does have an overhang design as the anode overhangs the cathode;

FIG. 4A illustrates a cross-sectional sketch of a group stack of SSB cells, wherein in these SSB cells the solid electrolyte is assembled to the cathode;

FIG. 4B illustrates a plan sketch of the stack of SSB cells shown in FIG. 4A;

FIG. 5A illustrates a layout sketch depictive of a process for screen printing or ink jet printing an electrical insulation ink around the edges of the anode and the cathode of a SSB cell shown in FIG. 3A;

FIG. 5B illustrates a cross-sectional sketch of the SSB cell having the electrical insulation ink around the edges of the anode and the cathode upon completion of the screen printing or ink jet process depicted in FIG. 5A;

FIG. 6A illustrates a layout sketch depictive of a process for roller printing an electrical insulation ink on the edges of an anode stack (the anode stack being comprised of the anode and the solid electrolyte which is laminated to the anode) of a SSB cell shown in FIG. 3A;

FIG. 6B illustrates a cross-sectional sketch of the SSB cell having the electrical insulation ink around the edges of the anode stack upon completion of the roller printing process depicted in FIG. 6A;

FIG. 7A illustrates a layout sketch depictive of a process for roller printing an electrical insulation ink on the edge of the anode stack adjacent the cathode tab area of a SSB cell shown in FIG. 3A; and

FIG. 7B illustrates a cross-sectional sketch of the SSB cell having the electrical insulation ink on the edge of the anode stack adjacent the cathode tab area of the SSB cell upon completion of the roller printing process depicted in FIG. 7A.

### DETAILED DESCRIPTION

Detailed embodiments of the present disclosure are disclosed herein; however, it is to be understood that the disclosed embodiments are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

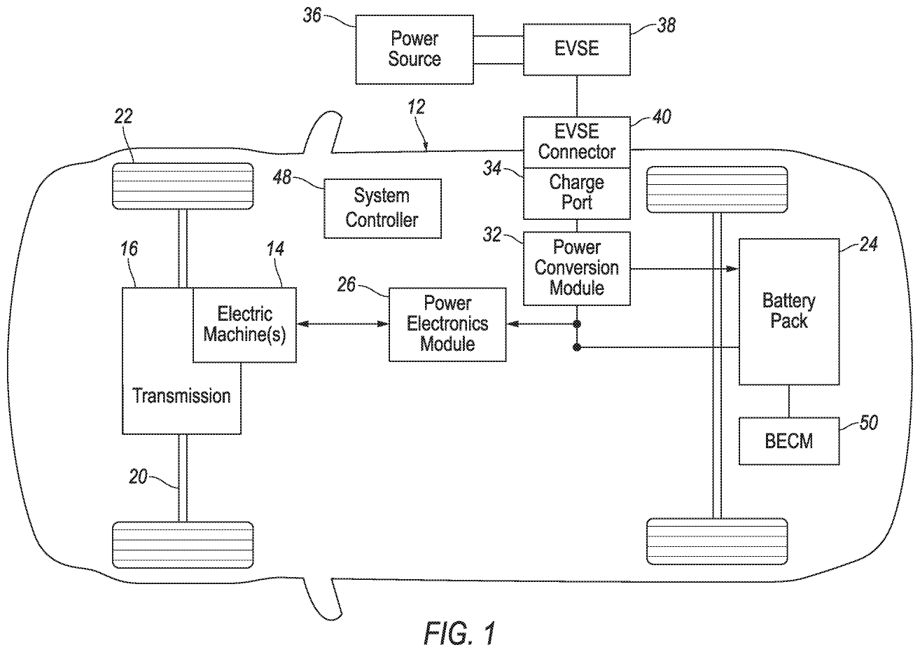

Referring now to FIG. 1, a block diagram of an electrified vehicle 12 in the form of a battery electric vehicle (BEV) is shown. BEV 12 includes a powertrain having one or more traction motors (“electric machine(s)”) 14, a traction battery (“battery” or “battery pack”) 24, and a power electronics module 26 (e.g., an inverter). In the BEV configuration, traction battery 24 provides all of the propulsion power and the vehicle does not have an engine. In other variations, the electrified vehicle may be a plug-in hybrid electric vehicle (PHEV) further having an engine.

Traction motor 14 is part of the powertrain of BEV 12 for powering movement of the BEV. In this regard, traction motor 14 is mechanically connected to a transmission 16 of BEV 12. Transmission 16 is mechanically connected to a drive shaft 20 that is mechanically connected to wheels 22 of BEV 12. Traction motor 14 can provide propulsion capability to BEV 12 and is capable of operating as a generator. Traction motor 14 acting as a generator can recover energy that may normally be lost as heat in a friction braking system of BEV 12.

Traction battery 24 stores electrical energy that can be used by traction motor 14 for propelling BEV 12. Traction battery 24 typically provides a high-voltage (HV) direct current (DC) output. Traction battery 24 is electrically connected to power electronics module 26. Traction motor 14 is also electrically connected to power electronics module 26. Power electronics module 26, such as an inverter, provides the ability to bi-directionally transfer energy between traction battery 24 and traction motor 14. For example, traction battery 24 may provide a DC voltage while traction motor 14 may require a three-phase alternating current (AC) current to function. Inverter 26 may convert the DC voltage to a three-phase AC current to operate traction motor 14. In a regenerative mode, inverter 26 may convert three-phase AC current from traction motor 14 acting as a generator to DC voltage compatible with traction battery 24.

In addition to providing electrical energy for propulsion of BEV 12, traction battery 24 may provide electrical energy for use by other electrical systems of the BEV such as HV loads like fan, electric heater, and air-conditioner systems and low-voltage (LV) loads such as an auxiliary battery.

Traction battery 24 is rechargeable by an external power source 36 (e.g., the grid). External power source 36 may be electrically connected to electric vehicle supply equipment (EVSE) 38. EVSE 38 provides circuitry and controls to control and manage the transfer of electrical energy between external power source 36 and BEV 12. External power source 36 may provide DC or AC electric power to EVSE 38. EVSE 38 may have a charge connector 40 for plugging into a charge port 34 of BEV 12.

A power conversion module 32 of BEV 12, such as an on-board charger having a DC/DC converter, may condition power supplied from EVSE 38 to provide the proper voltage and current levels to traction battery 24. Power conversion module 32 may interface with EVSE 38 to coordinate the delivery of power to traction battery 24.

The various components described above may have one or more associated controllers to control and monitor the operation of the components. The controllers can be microprocessor-based devices. The controllers may communicate via a serial bus (e.g., Controller Area Network (CAN)) or via discrete conductors.

For example, a system controller 48 (“vehicle controller”) is present to coordinate the operation of the various components. Controller 48 includes electronics, software, or both, to perform the necessary control functions for operating BEV 12. In embodiments, controller 48 is a combination vehicle system controller and powertrain control module (VSC/PCM). Although controller 48 is shown as a single device, controller 48 may include multiple controllers in the form of multiple hardware devices, or multiple software controllers with one or more hardware devices. In this regard, a reference to a “controller” herein may refer to one or more controllers.

Controller 48 implements a battery energy control module (BECM) 50. BECM 50 is in communication with traction battery 24. BECM 50 is a traction battery controller operable for managing the charging and discharging of traction battery 24 and for monitoring operating parameters of traction battery 24. BECM 50 may implement algorithms to measure and/or estimate the operating parameters of traction battery 24. BECM 50 controls the operation and performance of traction battery 24 based on the operating parameters of the traction battery.

The operating parameters of traction battery 24 may include the temperature, the charge capacity, and the state of charge (SOC) of the traction battery. For reference, the charge capacity of traction battery 24 is indicative of the amount of electrical energy that the traction battery may store. The SOC of traction battery 24 is indicative of a present amount of electrical energy stored in the traction battery. The SOC of traction battery 24 may be represented as a percentage of a maximum amount of electrical energy that may be stored in the traction battery. Traction battery 24 may also have corresponding charge and discharge power limits that define the amount of electrical power that may be supplied to or by the traction battery at a given time.

Traction battery 24 may have one or more temperature sensors such as thermistors in communication with BECM 50 to provide data indicative of the temperature of battery cells of the traction battery for the BECM to monitor the temperature of the traction battery. BEV 12 may further include a temperature sensor to provide data indicative of ambient temperature for BECM 50 to monitor the ambient temperature.

Traction battery 24 is a solid-state traction battery (SSB) and is comprised of a plurality of battery cells. Each battery cell is comprised of a negative electrode (i.e., an anode), a positive electrode (i.e., cathode), and a solid electrolyte between the anode and the cathode. An anode current collector (e.g., copper foil) is arranged on the side of the anode opposite from the solid electrolyte whereby the anode is between the anode current collector and the solid electrolyte. A cathode current collector (e.g., aluminum foil) is arranged on the side of the cathode opposite from the solid electrolyte whereby the cathode is between the solid electrolyte and the cathode current collector. The current collectors of the battery cell are respectively connected to the current collectors of other battery cells of the SSB for all of the battery cells to be connected together such as in series or in parallel.

The battery cell components are arranged in a cell stack with the components stacked on one another. Particularly, the anode current collector, the anode, the solid electrolyte, the cathode, and the cathode current collector are stacked on one another in that order to form the battery cell. The battery cell components are in the form of layers (e.g., sheets) whereby the layers are stacked on one another. Further, multiple ones of the battery cells having the same layered configuration are stacked on one another to form a stacked group of battery cells.

SSB 24 may be a lithium-ion SSB. As such, the anode may be comprised of a lithium metal and the cathode may be comprised of a lithium metal oxide.

A SSB such a lithium-ion SSB may provide a more beneficial electrified vehicle battery solution with a higher energy density compared with a conventional traction battery such as a lithium-ion traction battery. In this regard, the battery cells of the conventional battery include liquid electrolytes and a separator (e.g., a porous polymer separator) between the anode and the cathode. In the SSB, the solid electrolyte physically separates the cathode and the anode thereby eliminating the need for the liquid electrolytes and the type of separator used in the conventional battery.

In a SSB cell design, the solid electrolyte is assembled (e.g., laminated) onto one of the electrodes (i.e., onto either the anode or the cathode). Lamination utilizing heat and/or pressure to attach a pre-cast, solid electrolyte layer onto the electrode is a favored method due to scalability and ease of implementation. However, unlike in the conventional battery cell where the surface area of the separator is larger than the surface areas of the anode and cathode, the solid electrolyte can only have a surface area as large as the surface area of the electrode upon which the solid electrolyte is laminated. (For instance, if the solid electrolyte is laminated upon the anode, then the surface area of the solid electrolyte can only be as large as the surface area of the anode.) This leads to a chance of short circuiting when there is any misalignment between the anode and the cathode or at tab regions of the current collectors. In short, there are chances of short circuiting in the SSB cell design which arise from the lamination process of the solid electrolyte onto one of the electrodes.

As an aside, some mitigation of the chance of short circuiting can be made by the anode and the cathode having differently sized surface areas, which is referred to as “electrode overhang”. For instance, in the conventional lithium-ion battery design using liquid electrolytes, the anode has a larger surface area than the cathode to prevent lithium plating near the edges of the anode. As such, the anode “overhangs” the cathode. The liquid electrolyte provides a lithium-ion pathway to all faces of the anode, causing premature lithiation at one or more edges of the anode which can lead to lithium plating. If the cathode overhangs the anode, then there may be insufficient area of the anode to accommodate the lithium sourced by the cathode during charging and this can lead to plating of lithium, formation of dendrites of Li that grow towards the cathode, and possibly shorting of the cell.

In the SSB design, the anode does not have to have a larger surface area than the cathode because the solid electrolyte only conducts lithium-ions to one face of the anode and thus the chance of lithium plating is much less. The relatively reduced size of the anode (namely, the surface area of the anode is reduced to be the same size as the cathode) results in increased energy density. However, the chance for short circuiting has to be prevented in order to validate this design change, which design change brings enhancement in energy density.

As disclosed herein, SSB 24 has a battery cell design in which one or more electrode edges (or side edges) is coated with electrical insulation material. More particularly, one or more edges of the electrode (e.g., the anode) to which the solid electrolyte is assembled and/or the other electrode (e.g., the cathode) is coated with electrical insulation material. The electrical insulation material on the anode and/or cathode edges reduces the chance of short circuiting when there is any misalignment between the anode and the cathode or at tab regions of the current collectors. As further disclosed herein, the electrical insulation material may be coated on the electrode edges by screen or ink jet printing or by printing with the use of a roller.

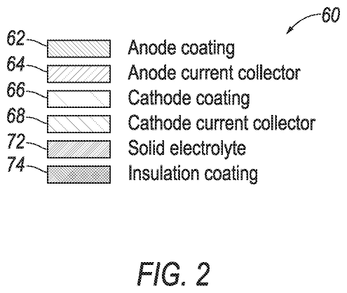

Referring initially to FIG. 2, a legend 60 of battery cell components shown in the sketches of the drawings is shown. The battery cell components set forth in legend 60 include an anode 62 (i.e., negative electrode) or anode coating (i.e., negative electrode material), an anode current collector 64 (i.e., negative electrode current collector), a cathode 66 (i.e., positive electrode) or cathode coating (i.e., positive electrode material), a cathode current collector 68 (i.e., positive electrode current collector), a solid electrolyte 72, and an electrical insulator 74 or electrical insulation coating.

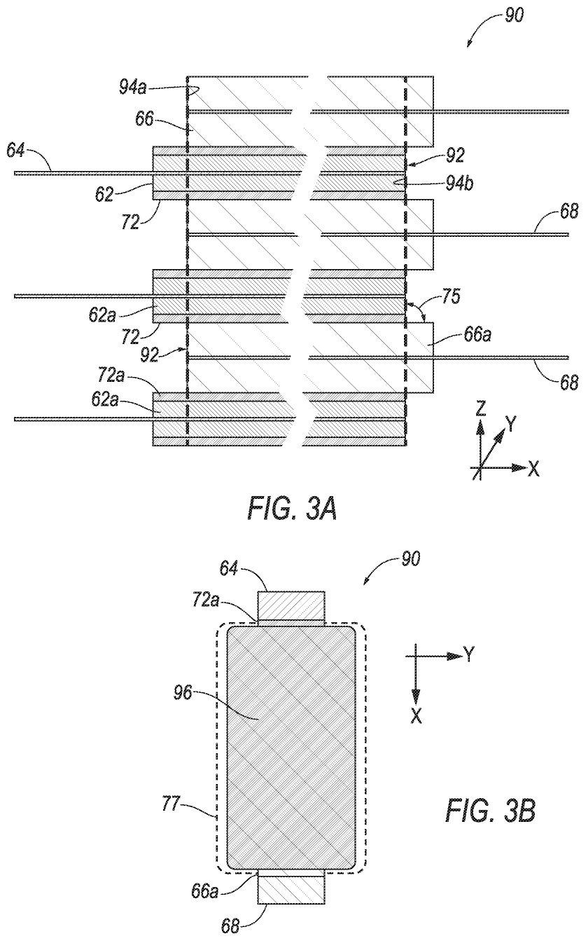

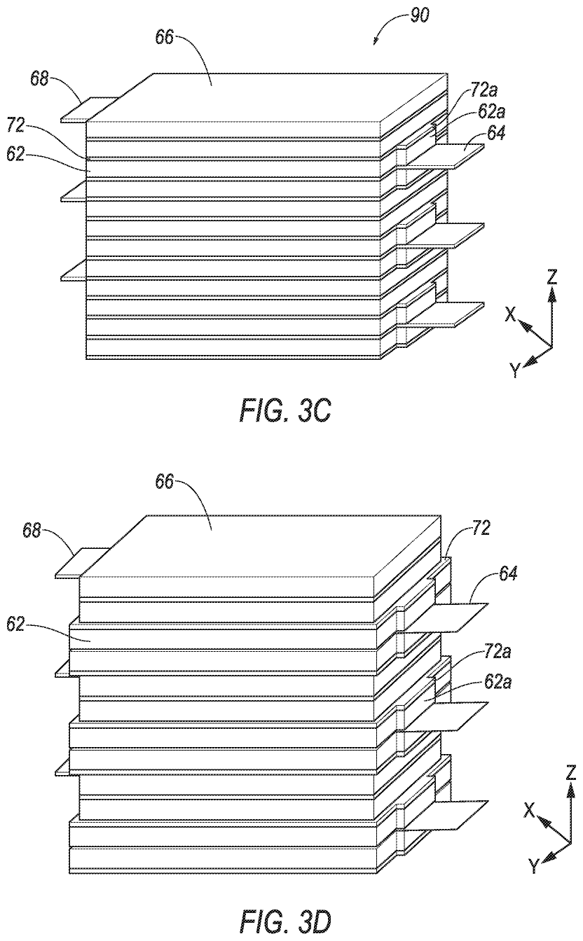

Referring now to FIG. 3A, a cross-sectional sketch of a group stack 90 of SSB cells 92 is shown. SSB cells 92 are stacked on top one another in a z-direction to form group stack 90. Each SSB cell 92 includes an anode 62, a solid electrolyte 72, and a cathode 66. On the individual SSB cell level, anode 62, solid electrolyte 72, and cathode 66 are stacked on one another in the z-direction with the solid electrolyte being sandwiched between the anode and the cathode.

Anode 62 and cathode 66 have the same size surface area in the x and y directions and are centrally (i.e., exactly) stacked opposed one another. Consequently, SSB cell 92 does not have an “overhang” design. That is, as shown in FIG. 3A, and as shown in FIG. 3C, anode 62 does not overhang cathode 66 and the cathode does not overhang the anode. Overhanging of a first electrode that is centrally stacked opposed a second electrode is a result of the first electrode having a larger surface area than the second electrode. For example, if anode 62 had a larger surface area than cathode 66, then sides of the anode would extend beyond corresponding sides of the cathode in the x-direction and/or the y-direction when the anode and the cathode are centrally stacked opposed one another. As such, in this case, as shown in FIG. 3D, anode 62 would overhang cathode 66. As anode 62 and cathode 66 have the same size surface area, none of the sides of the anode and the corresponding sides of the cathode extend beyond one another when the anode and the cathode are centrally stacked opposed one another. As set forth, SSB cell 92 is characterized by anode 62 and cathode 66 not overhanging one another except for the areas in the tab region where the coating extends beyond the electrode outline and into the tab region.

SSB cell 92 further includes an anode current collector 64 and a cathode current collector 68. Anode current collector 64 is arranged on the surface of anode 62 opposite from the surface of the anode facing solid electrolyte 72. Likewise, cathode current collector 68 is arranged on the surface of cathode 66 opposite from the surface of the cathode facing solid electrolyte 72.

A portion of anode current collector 64 in the form of a tab extends out from the corpus of SSB cell 92. Likewise, a portion of cathode current collector 68 in the form of a tab extends out from the corpus of SSB cell 92. In this example, the anode current collector tab and the cathode collector tab extend out from the corpus of SSB cell 92 past opposite first and second shoulder lines 94a and 94b of group stack 92. The tabs are accessible to be respectively connected to the tabs of the current collectors of other SSB cells 92 in group stack 90 for SSB cells 92 to be connected in series or in parallel with one another.

Each electrode of SSB cell 92 has an overhanging electrode coating on the tab of the current collector of that electrode. Particularly, anode 62 has an overhanging electrode coating 62a on the tab of anode current collector 64; and cathode 66 has an overhanging electrode coating 66a on the tab of cathode current collector 68. Anode coating 62a and cathode coating 66a are extended to a short portion of the respective current collector tabs to prevent metal to electrode contact and to allow lamination of solid electrolyte 72 on these short portions of the current collector tabs to provide protection.

As described above, anode 62 and cathode 66 have the same size surface area in the x and y directions. However, the two surface areas do not have the same form as one another when anode 62 and cathode 66 are centrally stacked opposed one another because of the presence of overhanging electrode coatings 62a and 66a.

In the SSB cell design shown in FIG. 3A, SSB cell 92 is further characterized by solid electrolyte 72 being assembled (i.e., laminated) on anode 62. As solid electrolyte 72 is laminated on anode 62, the size of the surface area of the solid electrolyte can only be as large as the size of the surface area of the anode. In this example, solid electrolyte 72 has the same size surface area as anode 62. Further, the surface area of solid electrolyte 72 has the same form as anode 62. In this regard, a portion 72a of solid electrolyte 72 is laminated on anode coating 62a that is on the tab of anode current collector 64.

Referring now to FIG. 3B, with continual reference to FIG. 3A, a plan sketch of group stack 90 of SSB cells 92 is shown. Group stack 90 further includes a cover substrate 96 arranged in the z-direction on the top side of the top SSB cell in group stack 90 and a base substrate (not shown) arranged in the z-direction on the bottom side of the bottom SSB cell in the group stack.

As indicated above, in a SSB cell design where the electrodes (i.e., the anode and the cathode) have the same size and are placed exactly upon one another, there is a chance of short circuiting in the area near the tab of the unlaminated electrode. This is because the tab of the unlaminated electrode is free to move and could be slightly bent to touch the unprotected edge of the laminated electrode. Further, there is a chance of short circuiting around the other edges of the electrodes in case of misalignment of the electrodes. The chance of short circuiting is higher near the tab of the unlaminated electrode, as the tab of the unlaminated electrode can move freely, and the chance of short circuiting is lower around the other edges of the electrodes.

In SSB cell 92, the tab of the unlaminated electrode is cathode coating 66a and the unprotected edge of the laminated electrode is the unprotected edge of anode 62. Cathode tab area 75 in FIG. 3A designates the area near cathode coating 66a and the unprotected edge of anode 62. The chance of short circuiting in area 75 is due to burrs that form during a notching process. For instance, in area 75, burrs from anode 62 are susceptible to short circuit by physically being touched by cathode coating 66a. As disclosed herein, the potential for short circuiting in cathode tab area 75 can be reduced by coating electrical insulation material at the unprotected edge of anode 62 and/or the corresponding edge of cathode 66.

Edge area 77 in FIG. 3B designates the area around the other edges of anode 62 and cathode 66. As noted, the chance of short circuiting in edge area 77 is due to misalignment between edges of anode 62 and cathode 66. As disclosed herein, the potential for short circuiting in edge area 77 can be reduced by coating electrical insulation material around the other edges of anode 62 and/or cathode 66.

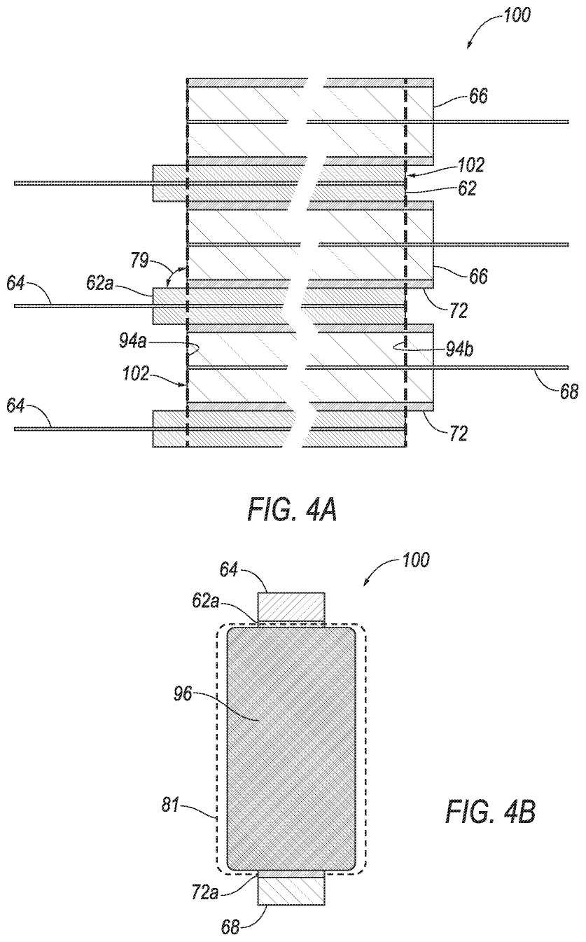

Referring now to FIG. 4A, with continual reference to FIGS. 3A and 3B, a cross-sectional sketch and a plan sketch of a group stack 100 of SSB cells 102 are respectively shown. In the SSB cell design shown in FIGS. 4A and 4B, SSB cell 102 is characterized by solid electrolyte 72 being assembled (i.e., laminated) on cathode 66. In this example, solid electrolyte 72 has the same size surface area as cathode 66. Further, the surface area of solid electrolyte 72 has the same form as cathode 66. In this regard, a portion 72a of solid electrolyte 72 is laminated on cathode coating 66a that is on the tab of cathode current collector 68.

In SSB cell 102, the tab of the unlaminated electrode is anode coating 62a and the unprotected edge of the laminated electrode is the unprotected edge of cathode 66. Anode tab area 79 in FIG. 4A designates the area near anode coating 62a and the unprotected edge of cathode 66. The chance of short circuiting in area 79 is due to burrs that form during a notching process. For instance, in area 79, burrs from cathode 66 are susceptible to short circuit by physically being touched by anode coating 62a. As disclosed herein, the potential for short circuiting in anode tab area 79 can be reduced by coating electrical insulation material at the unprotected edge of cathode 66 and/or the corresponding edge of anode 62.

Edge area 81 in FIG. 4B designates the area around the other edges of anode 62 and cathode 66. As noted, the chance of short circuiting in edge area 81 is due to misalignment between edges of anode 62 and cathode 66. As disclosed herein, the potential for short circuiting in edge area 81 can be reduced by coating electrical insulation material around the other edges of anode 62 and/or cathode 66.

As set forth, in the design of SSB cells 92 and 102 shown in FIGS. 3A and 4A, respectively, where anode 62 and cathode 66 have the same size and are placed exactly upon one another, there is a chance of short circuiting in the area near the tab of the unlaminated electrode (i.e., cathode tab area 75 in FIG. 3A in which cathode coating 66a is not laminated with solid electrolyte 72; and anode tab area 79 in FIG. 4A in which anode coating 62a is not laminated with solid electrolyte 72) and a chance of short circuiting around the other edges of the anode and the cathode in case of their misalignment.

As disclosed herein, the design of SSB cells 92 and 102 further entails coating an electrical insulating material around one or more edges of anode 62 and/or cathode 66 to effectively prevent short circuiting. The electrical insulating material can be made from electrical non-conductors such as solid electrolyte, polymer, or ceramics.

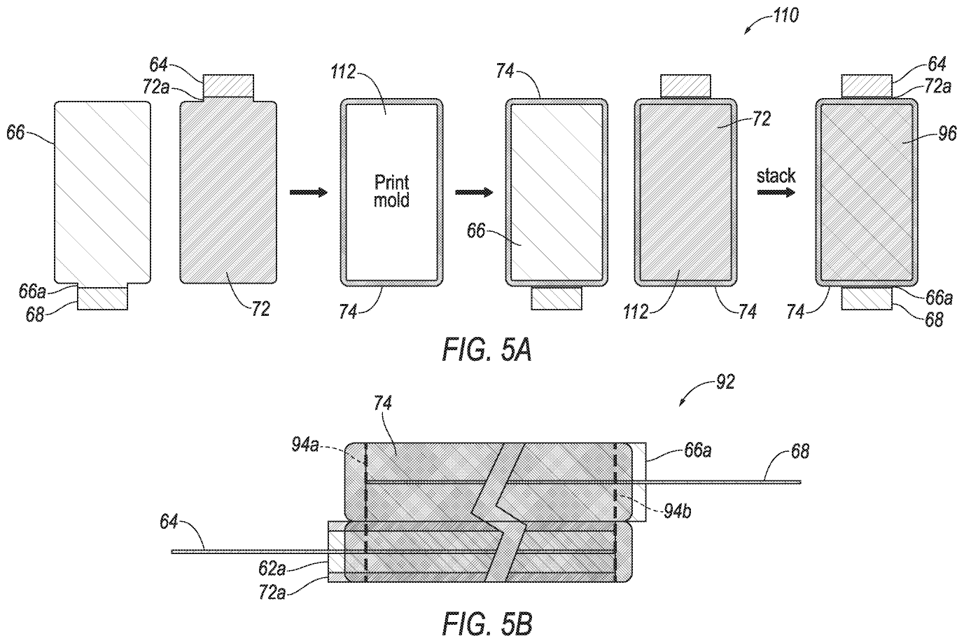

Referring now to FIG. 5A, a layout sketch depictive of a process 110 for screen printing or ink jet printing an electrical insulation ink 74 (i.e., an electrical insulation coating) around the edges of anode 62 and cathode 66 of a SSB cell 92 is shown. As a reminder, in SSB cell 92, solid electrolyte 72 is laminated to anode 62. Screen printing or ink jet printing an electrical insulation ink 74 around the edges of anode 62 and cathode 66 can be considered as a process of electrical insulation coating. Electrical insulation ink 74 is printed around the edges of anode 62 and cathode 66 using a print mold 112. The viscous coating is printed on each electrode sheet individually (i.e., electrical insulation ink 74 is printed on anode 62 and cathode 66 individually). Any excess of electrical insulation ink 74 would be squeezed out to empty spaces in the battery cell pouch by applying pressure on the pouch or vacuum sealing.

FIG. 5B illustrates a cross-sectional sketch of SSB cell 92 having electrical insulation ink 74 around the edges of anode 62 and cathode 66 upon completion of screen printing or ink jet printing process 110 depicted in FIG. 5A. Of course, screen printing or ink jet printing process 110 is applicable to SSB cell 102 in which solid electrolyte 72 is laminated to cathode 66.

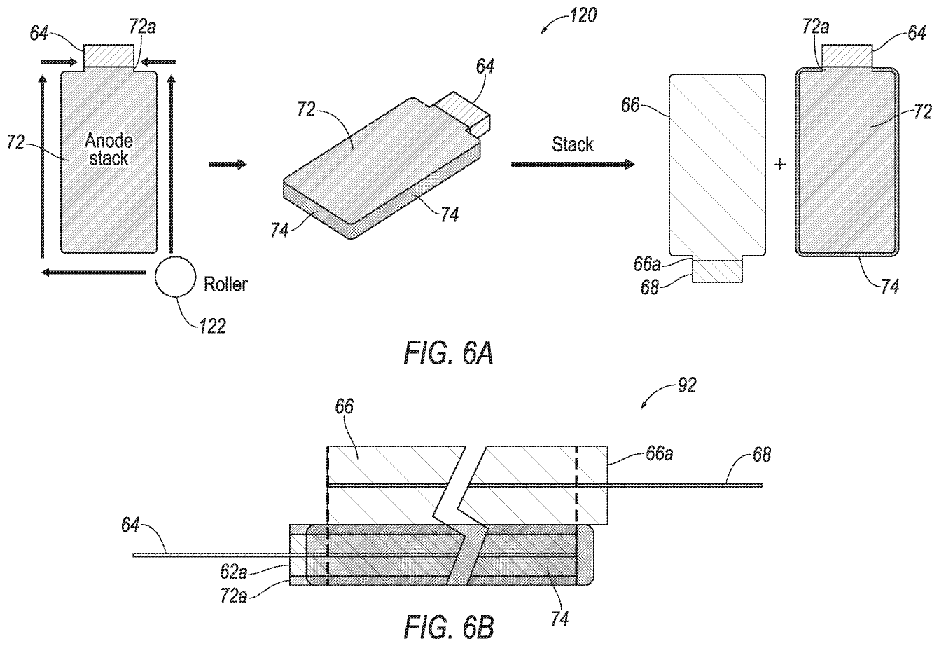

Referring now to FIG. 6A, a layout sketch depictive of a process 120 for roller printing electrical insulation ink 74 on the edges of an anode stack of a SSB cell 92 is shown. The anode stack is comprised of anode 62 and solid electrolyte 72 which is laminated to the anode. Electrical insulation ink 74 is printed around the edges of the anode stack (i.e., the edges of anode 62 and the edges of solid electrolyte 72) using a roller 122. Roller 122 is moved around the edges of the anode stack to print electrical insulation ink 74 around the edges of the anode stack. Roller 112 does not have to print electrical insulation ink 74 on the area of the edge of the anode stack adjacent to the tab of anode current collector 64 because there is minimal chance of short circuiting in this area between anode coating 62a and cathode 66.

Roller printing process 120 has the necessary provisions to ensure that the individual sheets can be separated easily after electrical insulation ink 74 is applied. If electrical insulation ink 74 is too viscous causing the sheets to stick, then a less viscous yet UV curable solution which is followed by UV radiation after cathode-anode assembly could be used as an alternative.

FIG. 6B illustrates a cross-sectional sketch of SSB cell 92 having electrical insulation ink 74 around the edges of the anode stack upon completion of roller printing process 120 depicted in FIG. 6A. Of course, roller printing process 120 is applicable to SSB cell 102 in which solid electrolyte 72 is laminated to cathode 66.

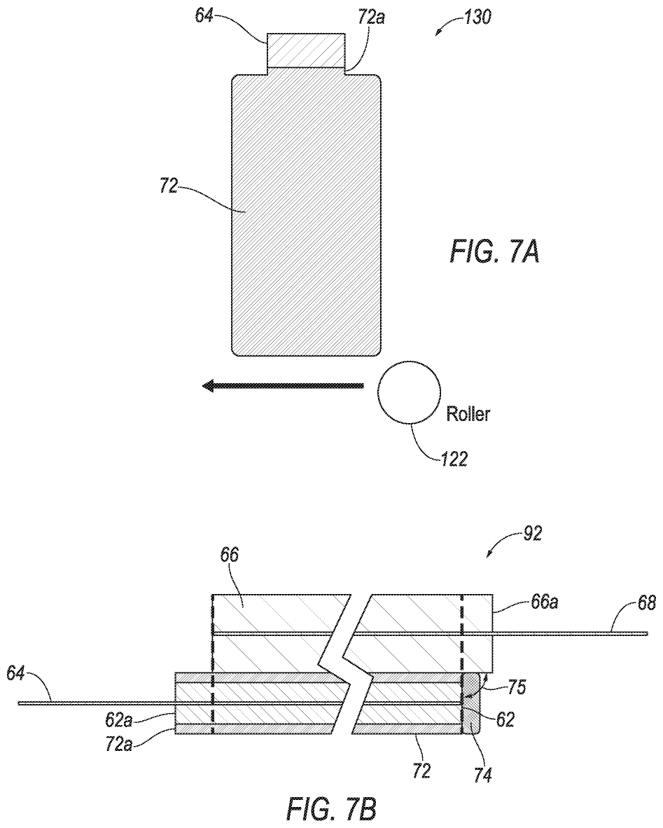

Referring now to FIG. 7A, a layout sketch depictive of a process 130 for roller printing electrical insulation ink 74 on the edge of the anode stack adjacent cathode tab area 75 of a SSB cell 92 is shown. Electrical insulation ink 74 is printed around the edge of the anode stack adjacent cathode tab area 75 using a roller 122. Roller printing process 130 provides the simplest approach of only printing electrical insulation ink 74 on the edge of the anode stack in the highest chance area for short circuiting (i.e., only printing on the edge the anode stack adjacent cathode tab area 75). As the other edges of the anode stack would not have electrical insulation ink 74 coated thereon, proper alignment of the electrode layers would be important for preventing short circuiting in this case.

FIG. 7B illustrates a cross-sectional sketch of SSB cell 92 having electrical insulation ink 74 on the edge of the anode stack adjacent cathode tab area 75 of the SSB cell upon completion of roller printing process 130 depicted in FIG. 7A. Of course, roller printing process 130 is applicable to SSB cell 102 in which solid electrolyte 72 is laminated to cathode 66.

Printing/coating an electrical insulation ink 74 is a simple, value-effective process which can be implemented relatively easily. An additional benefit of coating the edges of the electrodes is to fill any cracks or defects formed at the cut edge during the notching process with electrical insulation ink 74 (i.e., an elastic electrical insulation material) and thus suppressing degradation such as crack propagation during long term cycling. Suppression of this kind of degradation may be important for the laminated solid electrolyte layer, especially when the solid electrolyte is laminated on an electrode layer which is expected to undergo large volume change during cycling, as known for high specific capacity anodes such as silicon or lithium.

As described, a solid-state battery (SSB) in accordance with the present disclosure has a battery cell design in which one or more electrode edges is coated with electrical insulation material. In the case of the solid electrolyte being laminated to the anode, one or more edges of the anode stack (comprised of the anode and the solid electrolyte) is coated with electrical insulation material. The corresponding edges of the cathode may also be coated with electrical insulation material. In the case of the solid electrolyte being laminated to the cathode, one or more edges of the cathode stack (comprised of the cathode and the solid electrolyte) is coated with electrical insulation material. The corresponding edges of the anode may also be coated with electrical insulation material. The electrical insulation material may be coated on the electrode edges by screen or inkjet printing or by printing with the use of a roller. As such, proposed techniques to apply the electrical insulation material allow easy integration with current battery cell manufacturing processes.

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments of the present disclosure.

What is claimed is:

1. A solid-state battery cell comprising:
a first electrode;
a second electrode;
a solid electrolyte assembled to the first electrode and sandwiched between the first electrode and the second electrode in a stack;
the first electrode and the second electrode having a same size surface and the solid electrolyte having a surface no larger than the surface of the first electrode; and
an edge of the first electrode is coated with electrical insulating material.

2. The solid-state battery cell of claim 1 wherein:
an edge of the second electrode is coated with electrical insulating material.

3. The solid-state battery cell of claim 1 wherein:
the surface of the solid electrolyte is as large as the surface of the first electrode; and
an edge of the solid electrolyte is coated with electrical insulating material.

4. The solid-state battery cell of claim 1 further comprising:
a current collector having a main portion and a current collector tab extending therefrom, the second electrode being sandwiched between the main portion of the current collector and the solid electrolyte in the stack;
the second electrode having a second electrode tab, the second electrode tab extending along a portion of the current collector tab of the current collector; and
the edge of the first electrode that is coated with electrical insulating material is adjacent to the second electrode tab.

5. The solid-state battery cell of claim 4 further comprising:
a second current collector having a main portion and a current collector tab extending therefrom, the first electrode being sandwiched between the main portion of the second current collector and the solid electrolyte in the stack; and
the first electrode having a first electrode tab, the first electrode tab extending along a portion of the current collector tab of the second current collector.

6. The solid-state battery cell of claim 1 wherein:
the electrical insulating material coated on the edge of the first electrode is screen, ink jet, or roller printed on the edge of the first electrode.

7. The solid-state battery cell of claim 1 wherein:
the first electrode is an anode, and the second electrode is a cathode.

8. The solid-state battery cell of claim 1 wherein:
the first electrode is a cathode, and the second electrode is an anode.

9. The solid-state battery cell of claim 1 wherein:
the solid electrolyte is assembled to the first electrode by being laminated to the first electrode.

10. A solid-state battery cell comprising:
a first electrode having a surface and side edges, the surface of the first electrode extending in a x-y plane, the side edges of the first electrode arranged around a periphery of the surface of the first electrode and extending in a z-direction;
a second electrode having a surface and side edges, the surface of the second electrode extending in the x-y plane, the side edges of the second electrode arranged around a periphery of the surface of the second electrode and extending in the z-direction;
the surface of the first electrode and the surface of the second electrode being of a same size;
a solid electrolyte having a surface and side edges, the surface of the solid electrolyte extending in the x-y plane, the side edges of the solid electrolyte arranged around a periphery of the surface of the solid electrolyte and extending in the z-direction;
the solid electrolyte laminated to the first electrode such that the surface of the solid electrolyte is no larger than the surface of the first electrode;
the first electrode, the second electrode, and the solid electrolyte arranged along the z-direction in a stack with the solid electrolyte sandwiched between the first electrode and the second electrode; and
at least one of the side edges of the first electrode is coated with electrical insulating material.

11. The solid-state battery cell of claim 10 wherein:
at least one of the side edges of the second electrode corresponding to the at least one of the side edges of the first electrode is coated with electrical insulating material.

12. The solid-state battery cell of claim 10 wherein:
the surface of the solid electrolyte is as large as the surface of the first electrode; and
at least one of the side edges of the solid electrolyte corresponding to the at least one of the side edges of the first electrode is coated with electrical insulating material.

13. The solid-state battery cell of claim 10 further comprising:
a current collector having a main portion and a current collector tab extending therefrom, the second electrode being sandwiched between the main portion of the current collector and the solid electrolyte in the stack;
the second electrode having a second electrode tab, the second electrode tab extending along a portion of the current collector tab of the current collector; and
the at least one of the side edges of the first electrode includes a side edge of the first electrode adjacent to the second electrode tab.

14. The solid-state battery cell of claim 10 wherein:
the first electrode is an anode, and the second electrode is a cathode.

15. The solid-state battery cell of claim 10 wherein:
the first electrode is a cathode, and the second electrode is an anode.

16. An electrified vehicle comprising:
a traction battery having a first battery cell and a second battery cell, the first battery cell and the second battery cell being arranged in a group stack; and
wherein each battery cell includes a first electrode, a second electrode, and a solid electrolyte; and
in each battery cell, the solid electrolyte being assembled to the first electrode and sandwiched between the first electrode and the second electrode in a cell stack, the first electrode and the second electrode having a same size surface and the solid electrolyte having a surface no larger than the surface of the first electrode, and an edge of the first electrode is coated with electrical insulating material.

17. The electrified vehicle of claim 16 wherein:
in each battery cell, an edge of the second electrode is coated with electrical insulating material.

18. The electrified vehicle of claim 16 wherein:
in each battery cell, the surface of the solid electrolyte is as large as the surface of the first electrode and an edge of the solid electrolyte is coated with electrical insulating material.

19. The electrified vehicle of claim 16 wherein:
each battery cell further includes a current collector having a main portion and a current collector tab extending therefrom; and
in each battery cell, the second electrode being sandwiched between the main portion of the current collector and the solid electrolyte in the cell stack, the second electrode having a second electrode tab, the second electrode tab extending along a portion of the current collector tab of the current collector, and the edge of the first electrode that is coated with electrical insulating material is adjacent to the second electrode tab.

20. The electrified vehicle of claim 16 wherein:
the first electrode is an anode, and the second electrode is a cathode.
